(19) United States
(12) Patent Application Publication
(10) Pub. No.: US 2016/0379389 A1
(43) Pub. Date: Dec. 29, 2016

(54) DISPLAY CONTROL SYSTEM FOR VEHICLE

(71) Applicant: Toyota Jidosha Kabushiki Kaisha, Toyota-shi, Aichi-ken (JP)

(72) Inventors: Shunro FUKADA, Toyota-shi (JP); Satoshi SHIMIZU, Toyota-shi (JP)

(73) Assignee: TOYOTA JIDOSHA KABUSHIKI KAISHA, Toyota-shi, Aichi-ken (JP)

(21) Appl. No.: 15/039,870

(22) PCT Filed: Nov. 25, 2014
(86) PCT No.: PCT/IB2014/002554

§ 371 Date: May 27, 2016

(30) Foreign Application Priority Data
Nov. 28, 2013 (JP) 2013-245729

(51) Int. Cl. G06T 11/20; G09G 5/00; B60K 35/00

(52) U.S. Cl. CPC G06T 11/206; B60K 35/00; G09G 5/003; B60K 2350/1096; B60K 2350/203; B60K 2350/962; G06T 3/40

(57) ABSTRACT

The invention relates to a display control system including a display installed inside the vehicle. The driving force of wheels (84L, 84R, 86L, 86R) are calculated as needed, and magnitude and a direction of the vehicle acceleration (90, 90′) which change according to the driving force are displayed at the same time on a mimic vehicle diagram (70-86) displayed on the in-vehicle display. Thus, the driver can grasp the relationship between the driving force of each wheel (84L, 84R, 86L, 86R), and the magnitude and the direction of the vehicle acceleration (90, 90′). Accordingly, the driver can drive the vehicle in view of the relationship between the driving force of the wheels (84L, 84R, 86L, 86R), and the magnitude and direction of the vehicle acceleration (90, 90′).

### BACKGROUND OF THE INVENTION

1. Field of the Invention

The invention relates to a display control system for a vehicle, and in particular to a display control system that displays traveling conditions of the vehicle, using a mimic vehicle diagram displayed on an in-vehicle display.

2. Description of Related Art

A display system that displays traveling conditions of a vehicle, using a mimic vehicle diagram displayed on an in-vehicle display, is known. A torque display system for a vehicle as described in Japanese Patent Application Publication No. 2011-046362 (JP 2011-046362 A) is one example of the above type of display system. In the system of JP 2011-046362 A, the driving force of each drive wheel on the mimic vehicle diagram is indicated by a plurality of segments. As another example of display system, it has been proposed to display the vehicle acceleration or the steering angle alone.

### SUMMARY OF THE INVENTION

It has been proposed to display the distribution of the driving force among wheels during traveling, and inform the driver of a condition of distribution of the driving force as needed, as described in JP 2011-0466362 A. However, the display does not enable the driver to intuitively grasp the relationship between the distribution of the driving force and a parameter related to the distribution of the driving force. For example, if the distribution of the driving force changes, the vehicle acceleration changes according to the distribution of the driving force. However, in known display control systems, including the one as described in JP 2011-046362 A, the driving force of each wheel, and a parameter, such as the vehicle acceleration, related to the driving force, are respectively displayed alone. Thus, it is difficult for the driver to understand the relationship between the driving force of each wheel and the parameter. Accordingly, information concerning traveling conditions of the vehicle is not sufficiently conveyed to the driver, and there is still room for improvement in this respect.

The invention provides a display control system for a vehicle, which can convey sufficient information concerning traveling conditions of the vehicle to the driver.

According to one aspect of the invention, a display control system for a vehicle including a display installed inside the vehicle includes an electronic control unit. The electronic control unit is configured to control the display such that (a) traveling conditions of the vehicle are displayed using a mimic vehicle diagram displayed on the display, and (b) driving force of wheels, magnitude of a vehicle acceleration and a direction of the vehicle acceleration are displayed on one of the mimic vehicle diagram and a vicinity of the mimic vehicle diagram.

With the above arrangement, the driving force of the wheels, and the magnitude and direction of the vehicle acceleration which change according to the driving force, are displayed at the same time on the mimic vehicle diagram, or in the vicinity of the mimic vehicle diagram. Accordingly, the driver can grasp the relationship between the driving force of the wheels, and the magnitude and direction of the vehicle acceleration, as needed. Accordingly, the driver is able to drive the vehicle, in view of the relationship between the driving force of the wheels, and the magnitude and direction of the vehicle acceleration.

In the display control system according to the above aspect of the invention, the magnitude of the vehicle acceleration and the direction of the vehicle acceleration may be indicated by converting the vehicle acceleration into a form that enables the vehicle acceleration to be visually grasped on the mimic vehicle diagram, and the vehicle acceleration may be directly detected or calculated. With this arrangement, the vehicle acceleration directly detected or the vehicle acceleration calculated is converted into the form that enables the vehicle acceleration to be visually grasped on the mimic vehicle diagram. Accordingly, the conditions of the vehicle acceleration can be visually grasped with ease even during traveling of the vehicle.

In the display control system as described above, the electronic control unit may be configured to control the display such that (i) the magnitude and the direction of the vehicle acceleration are indicated by a position of a symbol placed on a plurality of concentric circles arranged about the same center, and (ii) a distance from the same center to the position of the symbol increases as the vehicle acceleration is larger. With this arrangement, the direction of the vehicle acceleration can be grasped from the position of the symbol, and the magnitude of the vehicle acceleration can be easily grasped from the distance between the center of the concentric circles and the symbol.

In the display control system as described above, the center of the concentric circles may be located in one of a vicinity of a center of the mimic vehicle diagram and a vicinity of a seated position of a driver. If the center of the concentric circles is located in the vicinity of the center of the mimic vehicle diagram, it is easy to see the indication of the vehicle acceleration. If the center of the concentric circles is located in the vicinity of the seated position of the driver, the vehicle acceleration can be sensually conveyed with ease to the driver.

In the display control system as described above, the electronic control unit may be configured to control the display such that a residual image indicating a trajectory of the symbol is displayed, and such that the symbol is displayed more lightly as a point in time at which the vehicle acceleration represented by the symbol is obtained is earlier. With the above arrangement, changes in the vehicle acceleration can be easily grasped from the trajectory of the vehicle acceleration.

In the display control system as described above, the electronic, control unit may be configured to control the display such that such that at least one of a size, a color density, or a color of the symbol is changed according to the position of the symbol. The electronic control unit may also be configured to control the display such that the size of the symbol is larger, the color of the symbol is darker, or the symbol indicated in another color, when the distance from the center of the concentric circles to the position of the symbol increases, or such that the size of the symbol is larger, the color of the symbol is darker, or the symbol is indicated in another color, as the distance from the center of the concentric circles to the symbol reaches a predetermined distance, as compared with the case where the distance from the center of the concentric circles to the symbol does not reach the predetermined distance. With this arrangement, the magnitude of the vehicle acceleration is made further clearer, through the use of the size, color density, and color of the symbol.

In the display control system as described above, the electronic control unit may be configured to control the display such that the concentric circles are displayed in perspective, in accordance with perspective display of the vehicle. With the concentric circles thus displayed in accordance with perspective display of the vehicle, the concentric circles on the display cause no feeling of strangeness.

In the display control system as described above, the electronic control unit may be configured to control the display such that the magnitude and the direction of the vehicle acceleration are indicated by an arrow having an origin located at one point on the mimic vehicle diagram. With this arrangement, the direction of the vehicle acceleration can be grasped from the direction of the arrow, and the magnitude of the vehicle acceleration can be easily grasped from the length or width of the arrow.

In the display control system as described above, the electronic control unit may be configured to control the display such that the symbol is fixed to the center of the concentric circles, or the symbol is not displayed, when an abnormality occurs to detection or calculation of the vehicle acceleration. With the above arrangement, the driver can immediately recognize the occurrence of the abnormality.

In the display control system as described above, the electronic control unit may be configured to control the display such that an amount of steering of a driver is indicated by a turning angle of a tire in the mimic vehicle diagram. With the above arrangement, the turning angle of the tire(s) is further displayed on the mimic vehicle diagram, and the driver can grasp change of the driving force or change of the vehicle acceleration due to change of the turning angle of the tire(s).

In the display control system as described above, the electronic control unit may be configured to change the turning angle of the tire relative to the amount of steering of the driver, at a time when driving force distribution control is switched from one mode to another. With this arrangement, the relationship between the amount of steering of the driver and the distribution of the driving force among the wheels can be grasped.

In the display control system as described above, the electronic control unit may be configured to set a gain such that the gain when the vehicle acceleration is low is larger than the gain when the vehicle acceleration is high, to make the display of the vehicle acceleration be more likely to change as the vehicle acceleration is lower. With this arrangement, in a regular operation region of the vehicle, the sensitivity or response of display of the vehicle acceleration to change thereof is increased, and even a small change in the vehicle acceleration is displayed. Thus, the driver can grasp such a change in the vehicle acceleration.

In the display control system as described above, the electronic control unit may be configured to set the turning angle to zero when an abnormality occurs to detection of the amount of steering of the driver. With this arrangement, the turning angle of the tire(s) does not change even if the amount of steering changes; therefore, the driver can immediately recognize an abnormality in detection of the amount of steering.

In the display control system as described above, the electronic control unit may be configured to perform one of the following operations when the abnormality occurs, so as to inform a driver of the abnormality; (a) turning off a light illuminating a part of or the whole of a display area of the mimic vehicle diagram, (b) blinking a part of or the whole of the display area of the mimic vehicle diagram, (c) displaying a character on the mimic vehicle diagram, (d) displaying a symbol on the mimic vehicle diagram, or (e) generating sound. With this arrangement, if an abnormality occurs, control for informing the driver of the abnormality is performed, so that the driver can surely recognize the occurrence of the abnormality.

In the display control system as described above, the vehicle includes a drive unit that performs at least one of distribution of driving force between front and rear wheels, or distribution of driving force between right and left wheels. With this arrangement, the distribution of the driving force between the front and rear wheels, and the distribution of the driving force between the right and left wheels, are displayed on the mimic vehicle diagram, and the vehicle acceleration is further displayed, so that the relationship between the distribution of the driving force among the respective wheels and the vehicle acceleration can be grasped as needed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view schematically showing the configuration of a vehicle to which the invention is applied;

FIG. 2 is a functional block diagram useful for explaining control functions of an electronic control unit that controls driving conditions of the vehicle of FIG. 1;

FIG. 3 is a view showing one example of mimic vehicle diagram shown in FIG. 2;

FIG. 4 is a view showing the relationship between the steering angle (the amount of steering) and the display amount of the turning angle of front wheels;

FIG. 5 is a view showing the relationship between the vehicle acceleration and the G display amount of the vehicle acceleration;

FIG. 6 is a view showing one example of mimic vehicle diagram displayed when an abnormality occurs;

FIG. 7 is a flowchart useful for explaining a principal part of control operation of the electronic control unit of FIG. 2, more specifically, control operation to display the mimic vehicle diagram that enables the driver to grasp traveling conditions of the vehicle as needed;

FIG. 8 is a view showing an example of mimic vehicle diagram according to another embodiment of the invention;

FIG. 9 is a view showing an example of mimic vehicle diagram according to a further embodiment of the invention;

FIG. 10 is a an enlarged view of a part of concentric circles indicating the vehicle acceleration in a mimic vehicle diagram according to a still further embodiment of the invention;

FIG. 11 is a view showing the relationship between the steering angle and display of the turning angle of the front wheels, according to a still another embodiment of the invention; and

FIG. 12 is a view showing the relationship between the vehicle acceleration and the G display amount (the distance of the concentric circle from the center of the concentric circles) of the vehicle acceleration.

### DETAILED DESCRIPTION OF EMBODIMENTS

Some embodiments of the invention will be described in detail with reference to the drawings. In the drawings, respective parts of the following embodiments are simplified, or deformed as needed, and the ratios of dimensions, shapes, etc. of the respective parts are not necessarily accurately depicted.

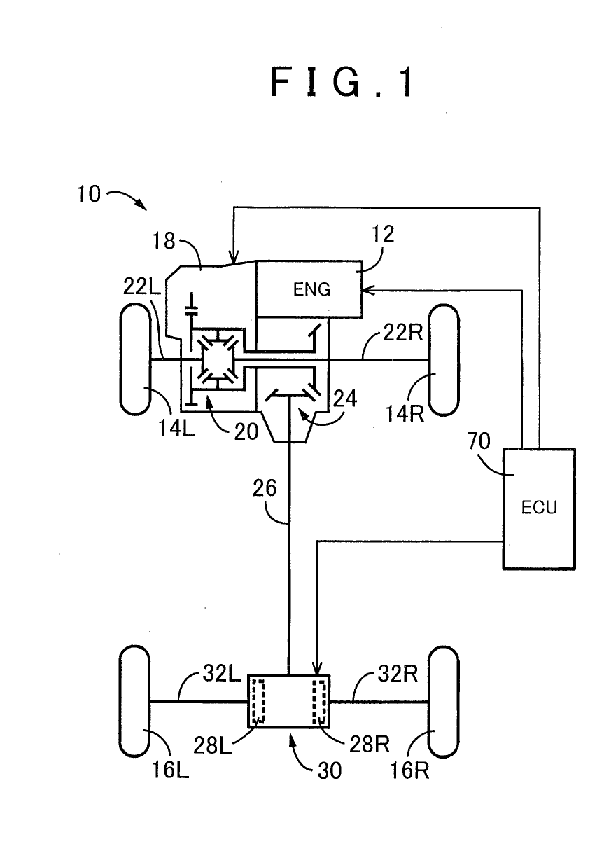

FIG. 1 schematically illustrates the configuration of a vehicle 10 to which this invention is applied, and is useful for explaining control functions and principal parts of a control system for performing various controls in the vehicle 10. In FIG. 1, the vehicle 10 includes an engine 12, right and left front wheels 14R, 14L (which will be called “front wheels 14” when they are not particularly discriminated from each other), right and left rear wheels 16R, 16L (which will be called “rear wheels 16” when they are not particularly discriminated from each other), a first power transmission pathway between the engine 12 and the front wheels 14, and a second power transmission pathway between the engine 12 and the rear wheels 16. In operation, power of the engine 12 is transmitted to the front wheels 14, via the first power transmission pathway, and power of the engine 12 is transmitted to the rear wheels 16, via the second power transmission pathway. The engine 12 is an internal combustion engine, such as a gasoline engine or a diesel engine, for example, and serves as a source of driving force which generates driving force. The front wheels 14 are driving wheels to which power is transmitted from the engine 12 via the first power transmission pathway, when the vehicle 10 is traveling in a two-wheel-drive mode (2WD mode) and a four-wheel-drive mode (4WD mode). Thus, the front wheels 14 are main driving wheels. The rear wheels 16 are driven wheels when the vehicle 10 is traveling in the 2WD mode, and are driving wheels to which power is transmitted from the engine 12 via the second power transmission pathway when the vehicle 10 is traveling in the 4WD mode. Thus, the rear wheels 16 are secondary driving wheels. Accordingly, the vehicle 10 is an FF-based front-rear-wheel drive vehicle (four-wheel-drive vehicle).

The first power transmission pathway includes a transmission 18, a front differential 20, right and left front-wheel axles 22R, 22L (which will be called “front-wheel axles 22” when they are not particularly discriminated from each other), and so forth. The second power transmission pathway includes the transmission 18, a transfer 24 as a front-rear-wheel power distribution device that distributes the power of the engine 12 to the rear wheels 16, a propeller shaft 26 as a driving force transmission shaft that transmits the power of the engine 12 distributed by the transfer 24, to the rear wheels 16, right-left-wheel driving force distribution mechanism 30 that distributes the driving force received from the propeller shaft 26 to the right and left rear wheels 16, right and left rear-wheel axles 32R, 32L (which will be called “rear-wheel axles 32” when they are not particularly discriminated from each other), and so forth. The vehicle 10 is one example of vehicle equipped with a drive system capable of distributing the driving force (torque) generated by the engine 12 to the front and rear wheels, according to traveling conditions of the vehicle 10, and also distributing the driving force (torque) to the right and left rear wheels 16. Thus, the right-left-wheel driving force distribution mechanism 30 provides a drive system (power transmission system) that assures low fuel consumption and excellent traction performance.

The transmission 18 constitutes a common power transmission pathway, as parts of the first power transmission pathway between the engine 12 and the front wheels 14, and the second power transmission pathway between the engine 12 and the rear wheels 16. The transmission 18 transmits the power of the engine 12 toward the front wheels 14 or the rear wheels 16. The transmission 18 may be a known planetary-gear-type multi-speed transmission in which a selected one of two or more gear positions having different speed ratios γ (=transmission input shaft speed Nin/transmission output shaft speed Nout) is established, or a known continuously variable transmission in which the speed ratio γ is steplessly or continuously changed, or a known synchromesh type parallel-two-shaft transmission, for example.

The right-left-wheel driving force distribution mechanism 30 transmits the driving force from the propeller shaft. 26 to the right and left rear wheels 16, according to traveling conditions of the vehicle. The right-left-wheel driving force distribution mechanism 30 includes a pair of electronically controlled couplings (28R, 28L) in the form of wet multiple disc clutches, for example, which are respectively provided on one side closer to the right rear wheel 16R and the other side closer to the left rear wheel 16L. In operation, the engaging forces of the pair of couplings (28R, 28L) are controlled, so that the distribution of the driving force between the right and left wheels and the distribution of the driving force between the front and rear wheels can be controlled. For example, the right-left-wheel driving force distribution mechanism 30 is constructed such that the driving force transmitted to the rear wheel 16L increases as the engaging force of the coupling 28L on the rear wheel 16L side increases, and the driving force transmitted to the rear wheel 16R increases as the engaging force of the coupling 28R increases. It is thus possible to continuously control the torque distribution of the right and left rear wheels 16 between 0:100 and 100:0, by controlling the engaging forces of the pair of couplings (28R, 28L). When both of the couplings (28L, 28R) are opened, no driving force is transmitted to the rear wheels 16. Namely, the vehicle 10 is brought into a two-wheel-drive traveling (2WD traveling) mode in which no driving force is distributed to the rear wheels 16. Since the right-left-wheel driving force distribution mechanism 30 is a known technology, its specific structure and operation will not be described in detail.

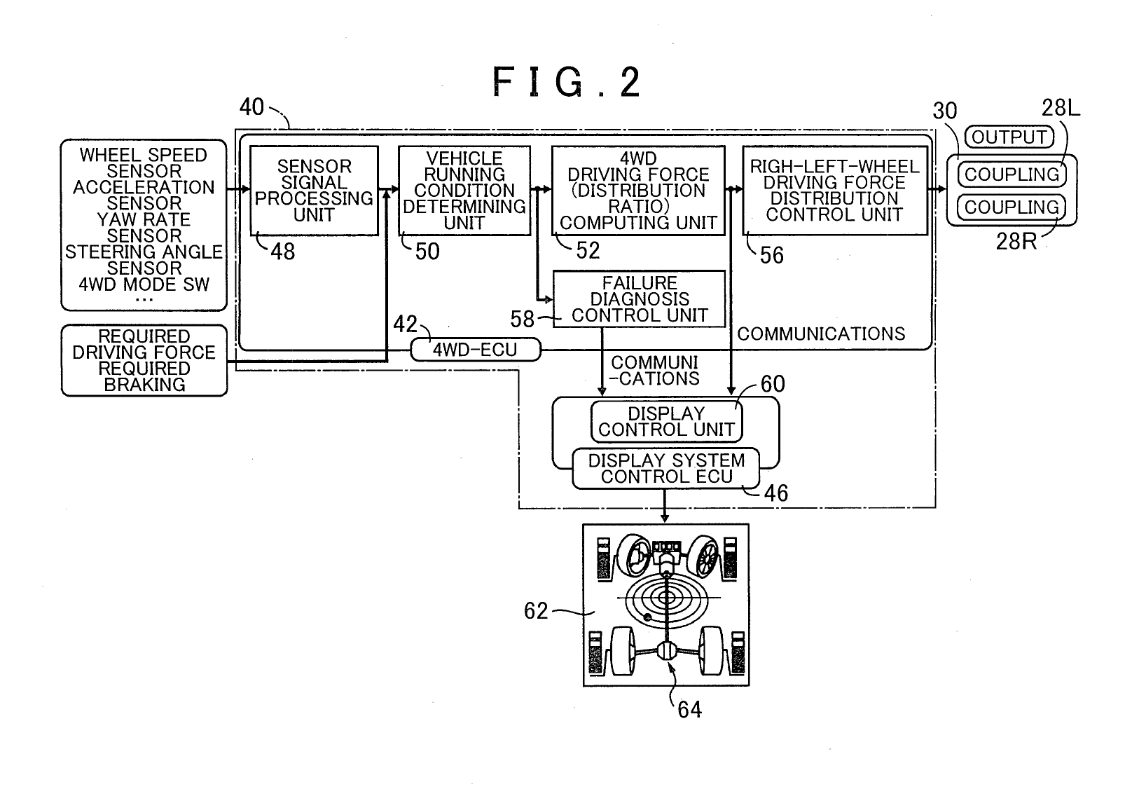

The vehicle 10 includes an electronic control unit 40 that controls the distribution of the driving force between the front and rear wheels and the distribution of the driving force between the right and left rear wheels 16, and also controls display of a mimic vehicle diagram that indicates traveling conditions of the vehicle 10. FIG. 2 is a functional block diagram useful for explaining control functions (control arrangement) of the electronic control unit 40 (including a 4WD-ECU 42, display system control ECU 46, etc.) that controls driving conditions of the vehicle 10. The electronic control unit 40 is configured to include a so-called microcomputer having CPU, RAM, ROM, input/output interface, etc., for example. The CPU performs signal processing according to programs stored in advance in the ROM, while utilizing the temporary storage function of the RAM, so as to control the driving conditions of the vehicle 10 according to the traveling conditions of the vehicle 10. The electronic control unit 40 is supplied with information detected by various sensors. For example, the electronic control unit 40 is supplied with information, such as each wheel speed Nr detected by a wheel speed sensor that detects the rotational speed of each wheel, vehicle acceleration G (including the vehicle longitudinal acceleration and the vehicle lateral acceleration) detected by an acceleration sensor, yaw rate Y (yaw angle) of the vehicle detected by a yaw rate sensor, steering angle θ detected by a steering angle sensor, and a mode switch signal from a 4WD mode switch provide at the driver's seat. The electronic control unit 40 also receives required driving force Tr (demand for driving force), required braking force Br (demand for braking), etc., from an engine ECU (E/G-ECU) (not shown) that controls the engine 12, etc. Although not illustrated in the drawings, the electronic control unit 40 is also supplied with the vehicle speed V detected by a vehicle speed sensor, accelerator pedal position Acc detected by an accelerator pedal position sensor, throttle opening θth detected by a throttle opening sensor, engine speed Ne detected by an engine speed sensor, and road gradient information, etc. from a navigation system. The vehicle acceleration G may be obtained by calculating the amount of change of the vehicle speed V detected by the vehicle speed sensor, as needed. The electronic control unit 40 and the mimic vehicle diagram 64 on an in-vehicle display 62 constitute the display control system of the invention.

The electronic control unit 40 is configured to functionally include a sensor signal processing unit 48, traveling condition determining unit 50, 4WD driving force computing unit 52, right-left-wheel driving force distribution control unit 56, failure diagnosis control unit 58, and a display control unit 60.

The sensor signal processing unit 48 processes voltage signals transmitted from various sensors, into information based on the sensors, and outputs the information to the vehicle traveling condition determining unit 50. The vehicle traveling condition determining unit 50 determines the optimum driving conditions of the vehicle 10, based on various kinds of information processed by the sensor signal processing unit 48. More specifically, the vehicle traveling condition determining unit 50 determines the optimum driving conditions of the vehicle 10, based on information, such as the wheel speed Nr detected by the wheel speed sensor, vehicle acceleration G detected by the acceleration sensor, yaw rate Y detected by the raw rate sensor, steering angle θ detected by the steering angle sensor, required driving force Tr, and the required braking force Br.

If the vehicle traveling condition determining unit 50 determines that the vehicle 10 is in a steady traveling state having small changes in the driving force of the vehicle, based on the accelerator pedal position Acc, required driving force Tr, and the vehicle speed V, for example, it determines that the vehicle 10 is to be driven in the two-wheel-drive traveling (2WD traveling) mode in which the pair of couplings (28R, 28L) provided in the right-left-wheel driving force distribution mechanism 30 are opened, so that no driving force is distributed to the rear wheels 16. If the vehicle traveling condition determining unit 50 determines that there are large changes in the driving force, it determines that the vehicle 10 is to be driven in the four-wheel-drive traveling (4WD traveling) mode in which the pair of couplings 28 (28R, 28L) are engaged or engaged while slipping, so, that the driving force is distributed to the rear wheels 16. If the vehicle traveling condition determining unit 50 determines that the vehicle 10 is not in the course of turning, based on the steering angle θ and the yaw rate Y, for example, it determines that the vehicle 10 is to be driven in the 2WD traveling mode. If the vehicle traveling condition determining unit 50 determines that the vehicle 10 is in the course of turning, it determines that the vehicle 10 is to be driven in the 4WD traveling mode in which the optimum driving force is distributed to the rear wheels 16 so that the vehicle 10 turns smoothly. If the vehicle traveling condition determining unit 50 determines that the vehicle 10 is traveling on a low-u road, such as a snow road, based on information from the navigation system, it determines that the vehicle 10 is to be driven in the 4WD traveling mode. If the vehicle traveling condition determining unit 50 determines, based on the wheel speeds Nr, that a difference between the rotational speeds of the front and rear wheels exceeds a predetermined value, it determines that the vehicle 10 is to driven in the 4WD traveling mode so as to curb slipping.

The 4WD driving force computing unit 52 calculates the optimum distribution of the driving force between the front and rear wheels and between the right and left rear wheels, based on input signals from various sensors. The 4WD driving force computing unit 52 calculates engine torque Te from signals, such as the throttle opening θ and the engine speed Ne during traveling, and calculates the distribution of the driving force between the front and rear wheels, so as to assure the maximum acceleration performance. If the 4WD driving force computing unit 52 determines that the operating status of the driver and change of the driving force of the vehicle are stable, based on the throttle opening θth, vehicle speed V, and the wheel speeds Nr, for example, the right-left-wheel driving force distribution control unit 56 reduces the amount of driving force distributed to the rear wheels 16, and places the vehicle 10 in a status close to the front-wheel-drive status, for improvement of the fuel efficiency. Also, the right-left-wheel driving force distribution control unit 56 reduces the amount of driving force distributed to the rear wheels 16, so as to prevent a tight corner braking phenomenon while the vehicle is turning at a low speed, for example. When it is determined, based on the vehicle traveling condition determining unit 50, that the vehicle 10 is to be driven in the 2WD traveling mode, the right-left-wheel driving force distribution control unit 56 controls the engaging forces of the pair of couplings 28 to zero. As a result, no driving force is distributed to the rear wheels 16.

The right-left-wheel driving force distribution control unit 56 outputs command signals to electromagnetic solenoids for controlling the engaging forces of the pair of couplings 28 of the right-left-wheel driving force distribution mechanism 30, so as to achieve the distribution of the driving force calculated by the traveling condition determining unit 50 and the 4WD driving force computing unit 52.

The failure diagnosis control unit 58 is operable to detect an abnormality in a system that switches the driving mode of the vehicle 10. For example, the failure diagnosis control unit 58 performs self-check of the communication status of the electronic control unit 40, each of the sensors, and so forth, when the power supply is turned on. Further, the failure diagnosis control unit 58 determines whether the pair of couplings 28 normally operate, by passing current through the electromagnetic solenoids that control the pair of couplings 28. If the failure diagnosis control unit 58 detects any abnormality, it transmits a signal indicative of the abnormality to the display system control ECU 46.

The display system control ECU 46 functionally includes a display control unit 60 that controls display conditions of the mimic vehicle diagram 64 provided on the in-vehicle display 62. The display control unit 60 displays driving conditions of the vehicle 10, using the mimic vehicle diagram 64 provided on the in-vehicle display 62, based on information from the vehicle traveling condition determining unit 50, 4WD driving force computing unit 52, and the failure diagnosis control unit 58. In the following, one example of display of the driving conditions displayed by the display control unit 60 on the mimic vehicle diagram 64 of the in-vehicle display 62 will be illustrated.

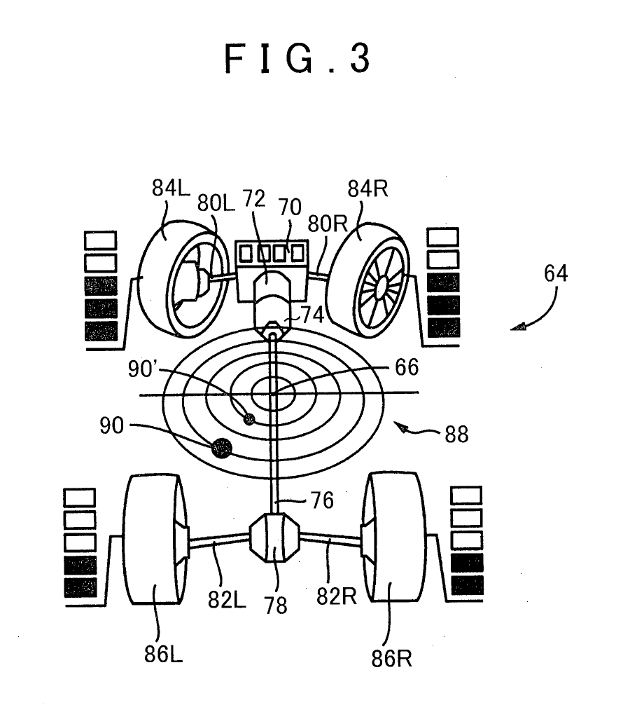

FIG. 3 shows one example of the mimic vehicle diagram 64 according to a first embodiment of the invention. In the mimic vehicle diagram 64 of FIG. 3, which is a perspective view, the vehicle 10 as seen from diagonally behind is drawn in perspective. More specifically, an engine 70 on display (corresponding to the engine 12), transmission 72 on display (corresponding to the transmission 18), transfer 74 on display (corresponding to the transfer 24), propeller shaft 76 on display (corresponding to the propeller shaft 26), right-left-wheel driving force distribution mechanism 78 on display (corresponding to the right-left-wheel driving force distribution mechanism 30), front-wheel axles 80R, 80L on display (corresponding to the front-wheel axles 22), rear-wheel axles 82R, 82L on display (corresponding to the rear-wheel axles 32), right and left front wheels 84R, 84L on display (corresponding to the right and left front wheels 14), and right and left rear wheels 86R, 86L on display (corresponding to the right and left rear wheels 16) are illustrated. Namely, main components that constitute the power train (drive system) of the vehicle 10 are displayed.

The display control unit 60 displays segments indicating the driving force (distribution) of each wheel, in the vicinity of each wheel (84R, 84L, 86R, 86L). In FIG. 3, a black segment indicates the ON state of a light, and a white segment indicates the OFF state of a light. As the number of segments that are in the ON state is larger, it indicates that the distribution of the driving force is larger. For example, in FIG. 3, three of the segments of each of the front wheels 84 are in the ON, state, and two of the segments of each of the rear wheels 86 are in the ON state. This indicates that the vehicle 10 is in a 4WD traveling mode in which the driving force is transmitted to each wheel (i.e., all of the four wheels). When the vehicle 10 is in a 2WD traveling mode, all of the segments of the rear wheels 86 are in the OFF state, and all (five) of the segments of each of the front wheels 84 are in the ON state. When the right-left-wheel driving force distribution mechanism 30 distributes different driving forces to the right wheel and the left wheel, the number of segments of the right rear wheel 86R which are in the ON state is different from that of the segments of the left rear wheel 86L which are in the ON state. The distribution ratio of the driving forces is calculated from the driving forces of respective wheels calculated by the 4WD driving force computing unit 52, and the number of segments that are turned on is determined, based on the magnitude of the driving force thus distributed.

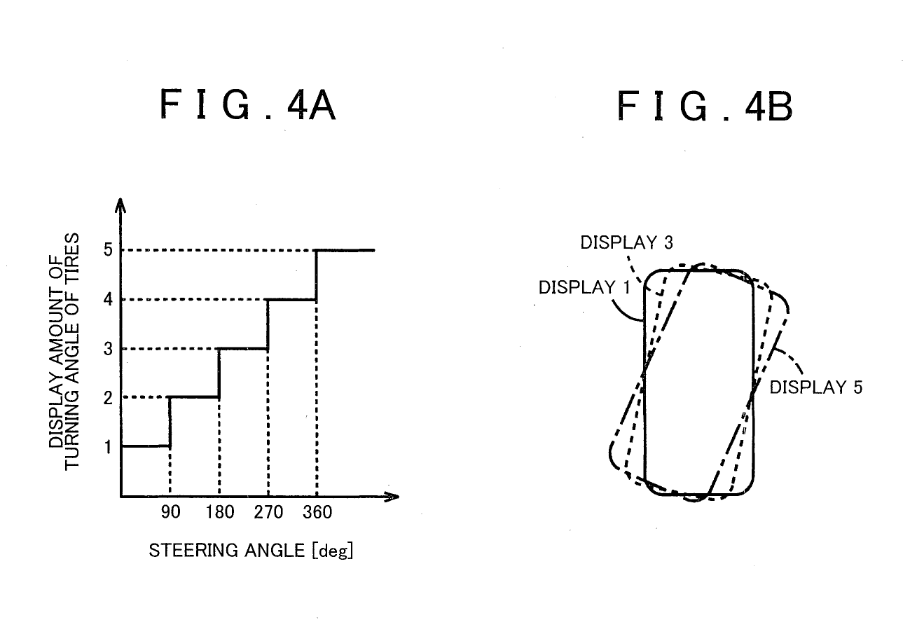

Also; the display control unit 60 changes the turning angle of the front wheels 84 in a stepwise fashion, according to the steering angle θ corresponding to the amount of steering of the driver, which is detected by the steering angle sensor, and displays the turning angle. For example, in the example of FIG. 3, the vehicle 10 is turning right. As the steering angle θ is larger, the turning angle of the front wheels 84 displayed becomes larger. If the vehicle is traveling straight ahead, the front wheels 84 are displayed in a straight-ahead fashion, like the rear wheels 86. Thus, the amount of steering of the driver (steering angle θ) is indicated by the turning angle of the front wheels 84. FIG. 4A and FIG. 4B show the relationship between the steering angle θ (steering amount) and the display amount of the turning angle of the front wheels 84. In FIG. 4A, the horizontal axis indicates the steering angle θ (the amount of steering), and the vertical axis indicates the display amount of the turning angle of the front wheels 84 (tires). The display amounts (1-5) of the turning angle on the vertical axis correspond to DISPLAY 1-DISLPLAY 5 (DISPLAY 2 and DISPLAY 4 are not illustrated) of the turning angle (slip angle) of the front wheel 84 displayed in FIG. 4B. More specifically, as shown in FIG. 4A, when the steering angle θ is in the range of 0 to 90 degrees, the display amount of the turning angel is 1. In this case, the front wheels 84 of FIG. 3 are displayed with the turning angle corresponding to DISPLAY 1 as indicated by the solid line in FIG. 4B (in a straight-ahead fashion). In FIG. 4B, the turning angle of the front wheel 84 is indicated in a plan view for easier understanding. However, the front wheels 84 are displayed in perspective in the mimic vehicle diagram 64 of FIG. 3. Also, as shown in FIG. 4A, if the steering angle θ is in the range of 180 to 270 degrees, the display amount of the turning angle shown in FIG. 4A is 3. In this case, the front wheels 84 of FIG. 3 are displayed with the turning angle corresponding to DISPLAY 3 as indicated by the broken line in FIG. 4B. Also, as shown in FIG. 4A, if the steering angle θ exceeds 360 degrees, the display amount of the turning angle is 5. In this case, the front wheels 84 of FIG. 3 are displayed with the turning angle corresponding to DISPLAY 5 as indicated by the one-dot chain line in FIG. 4B. In FIG. 4B, the display amounts 2 and 4 of the turning angle are not illustrated. However, in fact, the turning angle of the front wheels 84 corresponding to DISPLAY 2 between DISPLAY 1 and DISPLAY 3 exists, and the turning angle corresponding to DISPLAY 4 between DISPLAY 3 and DISPLAY 5 exits. The turning angle of the front wheels 84 displayed is larger as the number of DISPLAY is larger.

Also, the display control unit 60 displays the vehicle acceleration G measured by the acceleration sensor or calculated, by converting the magnitude and direction of the vehicle acceleration G into forms in which those of the acceleration G can be visually grasped, on the mimic vehicle diagram. In the vicinity of the center of the mimic vehicle diagram 64, a plurality of (5 in this embodiment) concentric circles 88 located about a common center 66 are displayed. These concentric circles 88 are displayed in perspective in accordance with perspective display of the mimic vehicle diagram 64. Further, a ball 90 (symbol in this invention) is displayed on one of the concentric circles. The magnitude and direction of the vehicle acceleration G are indicated by the concentric circles 88 and the ball 90. For example, in FIG. 3, the ball 90 is located on the left lower side of the center of the concentric circles. This indicates that the vehicle acceleration G is applied in a negative direction as a vehicle longitudinal direction, to the left of the vehicle. When the vehicle is accelerated while turning right, for example, the vehicle acceleration G is applied to the vehicle, in a negative direction as a longitudinal direction, to the left as a right-left direction. In this case, the ball 90 is displayed on the left, lower side as shown in FIG. 3. When the vehicle is accelerated while turning left, for example, the vehicle acceleration G is applied to the vehicle, in a negative direction as a longitudinal direction, to the right as a right-left direction. Thus, the ball 90 is display to the lower right. When the vehicle is decelerated while turning right, the vehicle acceleration G is applied to the vehicle, in a positive direction as a longitudinal direction, to the left as a right-left direction. Thus, the ball 90 is displayed to the upper left. When the vehicle is decelerated while turning left, the vehicle acceleration G is applied to the vehicle, in a positive direction as a longitudinal direction, to the right as a right-left direction. Thus, the ball 90 is displayed to the upper right. Further, increase of the distance from the center 66 of the concentric circles to the ball 90 indicates increase of the magnitude of the vehicle acceleration G.

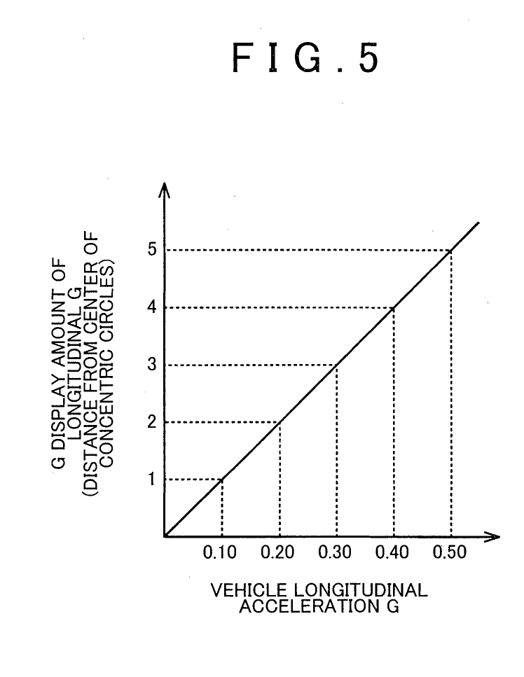

FIG. 5 indicates the relationship between the vehicle longitudinal acceleration G and the G display amount (the distance of the concentric circle in question from the center of the concentric circles in FIG. 3). In FIG. 5, the horizontal axis indicates the vehicle longitudinal acceleration G (vehicle acceleration G) that is actually detected or calculated, and the vertical axis indicates the G display amount (the distance of the concentric circle from the center of the concentric circles) of the vehicle longitudinal acceleration G. As shown in FIG. 5, when the vehicle acceleration G is 0.1 G, the G display amount is 1. The G display amount is 2 when the vehicle acceleration G is 0.2 G, and the G display amount is 3 when the vehicle acceleration G is 0.3 G. The G display amount is 4 when the vehicle acceleration G is 0.4 G, and the G display amount is 5 when the vehicle acceleration G is 0.5 G or larger. The number of the G display amounts corresponds to the number of the plurality of concentric circles 88 of FIG. 3. More specifically described, in FIG. 3, the radially innermost circle corresponds to the concentric circle 88 of the G display amount 1, and the concentric circles of the G display amount 2, G display amount 3, G display amount 4, and the G display amount 5 (the radially outermost circle) are arranged in this order, radially outwards from the concentric circle (the innermost circle) corresponding to the G display amount 1, toward the radially outermost concentric circle 88. Once the G display amount is determined, the ball 90 is placed on the corresponding concentric circle. When the G display amount is 1, for example, the ball 90 is placed on the concentric circle (the innermost circle) corresponding to the G display amount 1. Thus, the display control unit 60 determines the G display amount based on FIG. 5, from the detected vehicle acceleration G, and displays the ball 90 on the concentric circle corresponding to the determined G display amount. As the vehicle acceleration G is larger, the G display amount is larger; therefore, the ball 90 is placed on the radially outer concentric circle 88, and is located farther away from the center 66. While the G display amount is determined based on the vehicle longitudinal acceleration in FIG. 5, the G display amount may be determined in view of the vehicle lateral acceleration as well as the vehicle longitudinal direction.

As the location of the ball 90 gets farther away from the center 66 of the concentric circles 88, the size of the ball 90 displayed becomes larger, or the color of the ball 90 displayed becomes darker, or the color of the ball 90 is changed, so that the ball 90 is continuously changed. In this manner, the magnitude of the vehicle acceleration G can be made further clearer. For example, the ball 90 of FIG. 3 is displayed such that its size is larger than that of a ball 90′ placed-on the concentric circle 88 located radially inwardly of the ball 90. Alternatively, each time the distance between the center 66 of the concentric circles 88 and the ball 90 reaches (approaches) one of predetermined distances set in advance, the size of the ball 90 displayed becomes larger, or the color of the ball 90 displayed becomes darker, or the color of the ball 90 is changed, so that the ball 90 is changed in a stepwise fashion. In this manner, too, the magnitude of the vehicle acceleration G can be made further clearer.

The display control unit 60 displays the driving force of each wheel, the vehicle acceleration G, and the turning angle of the front wheels 84, at the same time. Accordingly, the relationship of the vehicle acceleration G with the driving force of each wheel can be grasped, and the driver is able to drive the vehicle 10 according to the relationship. Further, the turning angle of the front wheels 84 is displayed in a stepwise fashion according to the steering angle θ, so that the driver can grasp changes in the driving force distribution and the vehicle acceleration G based on changes in the turning angle of the front wheels 84.

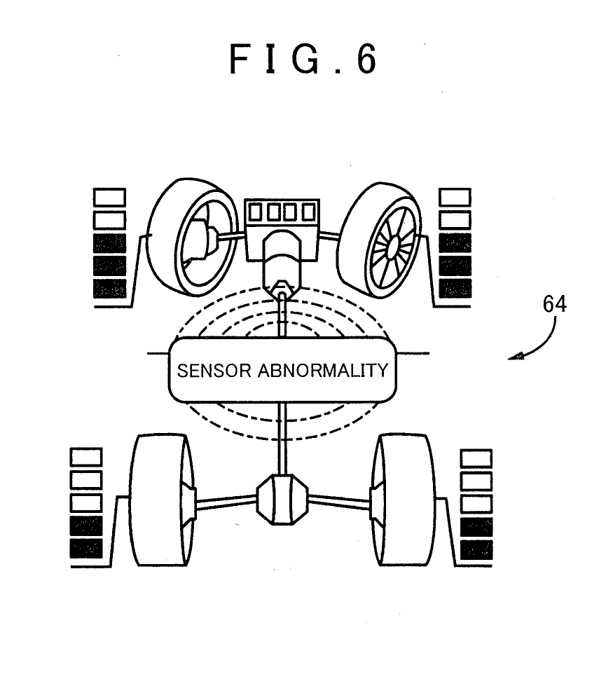

If the failure diagnosis control unit 58 determines that an abnormality occurs to the acceleration sensor, for example, and the vehicle acceleration G cannot be detected, the display control unit 60 displays the ball 90 such that it is fixed to the center 66 of the concentric circles 88, or does not display the ball 90. In this manner, the display control unit 60 informs the driver of occurrence of the abnormality. As another method of informing the driver of occurrence of the abnormality, the mimic vehicle diagram as a whole or the concentric circles 88 may be caused to blink, or its light may be turned off, or the concentric circles 88 may be indicated by broken lines, or like, as shown in FIG. 6, so as to inform the driver of occurrence of the abnormality. It is also possible to inform the driver of occurrence of the abnormality, by displaying characters or symbols as shown in FIG. 6, on the mimic vehicle diagram. It is also possible to inform the driver by sound of occurrence of the abnormality. These methods may be combined as appropriate so as to inform the driver of occurrence of the abnormality.

If the failure diagnosis control unit 58 determines that an abnormality occurs to the steering angle sensor, for example, and the steering angle θ cannot be detected, the display control unit 60 informs the driver of occurrence of the abnormality, by fixing the turning angle of the front wheels 84 to zero in the mimic vehicle diagram 64, for example. As another method of informing the driver of the abnormality, a light illuminating the front wheels 84 may be turned off, or caused to blink, so as to inform the driver of the abnormality. It is also possible to inform the abnormality using characters or symbols as shown in FIG. 6, or inform the abnormality by sound. These methods may be combined as appropriate so as to inform the driver of occurrence of the abnormality.

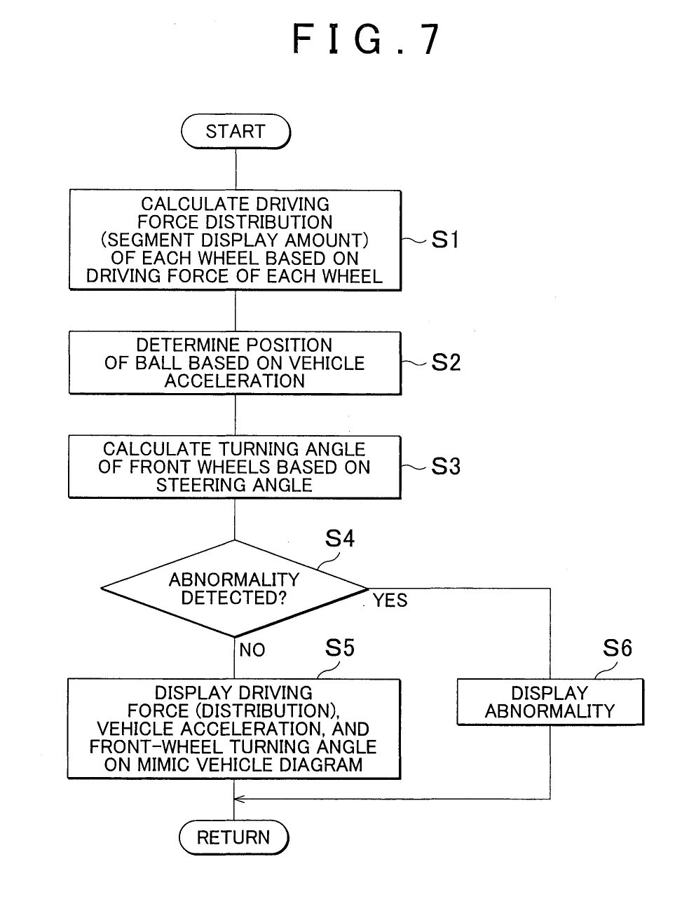

FIG. 7 is a flowchart illustrating a principal path of control operation of the electronic control unit 40, in particular, control operation to display a mimic vehicle diagram with which the driver can grasp traveling conditions of the vehicle 10 as needed. The flowchart of FIG. 7 is repeatedly executed in extremely short cycles of several milliseconds to several tens of milliseconds, for example.

Initially, in step S1 corresponding to the 4WD driving force computing unit 52 and the display control unit 60, the driving force of each wheel is calculated, and the distribution of the driving force among the respective wheels, namely, the display amount of segments of each wheel, is calculated from the driving force of each wheel. In step S2 corresponding to the display control unit 60, the location of the ball 90 displayed on one of the concentric circles of the mimic vehicle diagram 64 is calculated, based on the vehicle acceleration G obtained by the accelerator sensor or by calculation. In step S3 corresponding to the display control unit 60, the turning angle of the front wheels 84 is determined based on the steering angle θ detected by the steering angle sensor. Then, in step S4 corresponding to the failure diagnosis control unit 58, it is determined whether an abnormality has occurred to the acceleration sensor or the steering angle sensor, for example. If a negative decision (NO) is obtained in step S4, step S5 corresponding to the display control unit 60′ is executed so as to display the segment display amount of each wheel, the location of the ball 90 on the concentric circles, and the turning angle of the front wheels 84, which are determined in steps S1 to S3, on the mimic vehicle diagram. If an affirmative decision (YES) is obtained in step S4, step S6 corresponding to the display control unit 60 is executed so as to switch to display that informs the driver of occurrence of the abnormality, as shown in FIG. 6 by way of example.

As described above, according to this embodiment, the driving force of each wheel, and the magnitude and direction of the vehicle acceleration G that changes according to the driving force, are displayed at the same time on the mimic vehicle diagram 64. As a result, the driver is able to grasp the relationship between the driving force of each wheel, and the magnitude and direction of the vehicle acceleration G, as needed. Accordingly, the driver is able to drive the vehicle, in view of the relationship between the driving force of each wheel, and the magnitude and direction of the vehicle acceleration G.

According to this embodiment, the vehicle acceleration G detected by the acceleration sensor or the calculated vehicle acceleration G is converted into a form in which the vehicle acceleration G can be visually grasped on the mimic vehicle diagram. Thus, the driver can visually grasp the form of the vehicle acceleration G with ease even during traveling of the vehicle.

Also, according to this embodiment, the driver is able to grasp the direction of the vehicle acceleration G from the location of the ball 90 placed on the concentric circles 88. Also, the driver is able to easily grasp the magnitude of the vehicle acceleration G from the distance between the center 66 of the concentric circles 88 and the ball 90.

Also, according to this embodiment, the center 66 of the concentric circles 88 is located in the vicinity of the center of the mimic vehicle diagram 64. Accordingly, display of the vehicle acceleration G is easy to view.

Also, according to this embodiment, the size, color density, or color of the ball 90 is changed according to the location of the ball 90. As the distance from the center 66 of the concentric circles 88 to the ball 90 is larger, the size of the ball 90 displayed becomes larger, or the color of the ball 90 becomes darker, or the ball 90 is displayed in another color. In this manner, the magnitude of the vehicle acceleration G is made further clearer.

Also, according to this embodiment, the concentric circles 88 depicted in the mimic vehicle diagram 64 are displayed in perspective in accordance with the perspective display of the vehicle. Accordingly, the concentric circles 88 cause no feeling of strangeness on display.

Also, according to this embodiment, when any abnormality occurs to detection or calculation of the vehicle acceleration G, the ball 90 is not displayed. Thus, the driver can immediately recognize occurrence of the abnormality. Also, when any abnormality occurs to detection of the steering angle θ, the turning angle of the front wheels 84 is set to zero. Thus, the driver can immediately recognize the abnormality in detection of the steering angle θ. Further, when the abnormality occurs, a light illuminating a part or the whole of a display area of the mimic vehicle diagram 64 is turned off or caused to blink, or characters or symbols are displayed on the mimic vehicle diagram, or sound is generated, so as to inform the driver of occurrence of the abnormality. Thus, the driver can surely recognize occurrence of the abnormality.

Also, according to this embodiment, the steering angle θ is displayed in the form of the turning angle of the front wheels 84 in the mimic vehicle diagram 64. Thus, the driver can grasp changes in the driving force or changes in the vehicle acceleration G due to changes in the turning angle of the front wheels 84, as needed.

Next, other embodiments of the invention will be described. In the following description, the same reference numerals are assigned to the same or corresponding portions or elements as those of the above-described embodiment, and these portions or elements will not be explained.

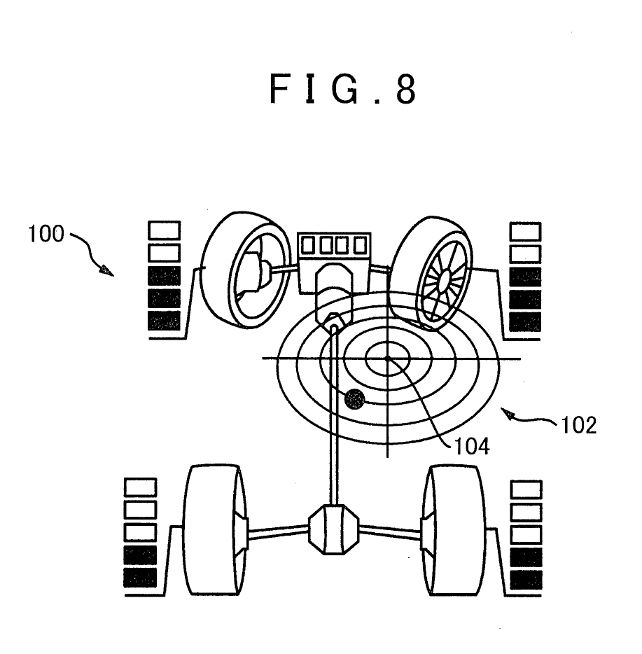

FIG. 8 shows one example of mimic vehicle diagram 100 according to a second embodiment of the invention. In the mimic vehicle diagram 100 of FIG. 8, a center 104 of a plurality of concentric circles 102 indicating the vehicle acceleration G is set in the vicinity of the seated position of the driver. With the center 104 of the concentric circles 102 thus set to this position, the vehicle acceleration G is displayed with respect to the center located at the position of the driver in the mimic vehicle diagram 100. Accordingly, the driver can sensually grasp the vehicle acceleration G with further ease.

As described above, this embodiment provides the same effects as those of the above-described embodiment, and also provides an effect of enabling the driver to sensually grasp the vehicle acceleration G with further ease, by setting the center 104 of the concentric circles 102 in the vicinity of the seated position of the driver.

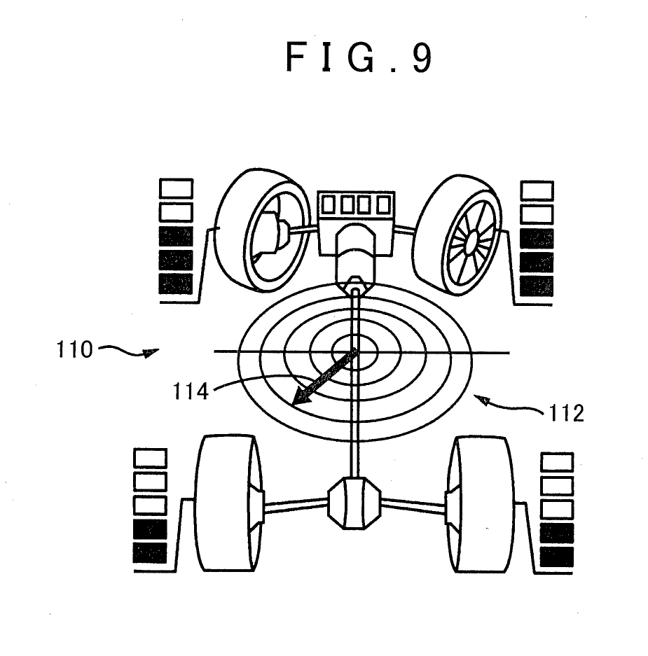

FIG. 9 shows one example of mimic vehicle diagram 110 according to a third embodiment of the invention. In the mimic vehicle diagram 110 of FIG. 9, the vehicle acceleration G is indicated by an arrow 114, in place of the ball 90 that indicates the magnitude and direction of the vehicle acceleration G in the mimic vehicle diagram 64 shown in FIG. 3. The arrow 114 shown in FIG. 9 has a base located at the center of concentric circles 112, and its distal end points in a direction in which the vehicle acceleration G is applied. Also, the length of the arrow 114 indicates the magnitude of the vehicle acceleration G, and the magnitude of the vehicle acceleration G increases as the length of the arrow 114 increases. Thus, the direction and magnitude of the vehicle acceleration G may be indicated by use of the arrow 114. If an abnormality occurs to detection of the vehicle acceleration G, a light illuminating the arrow may be turned off or caused to blink, for example, so as to inform the driver of the occurrence of the abnormality. Also, the width of the arrow 114 may be increased as the vehicle acceleration G increases, so that the magnitude of the vehicle acceleration G can be further clearly indicated.

As described above, this embodiment provides the same or similar effects as the above-described embodiments, and the magnitude of the vehicle acceleration G is indicated by using the arrow 114 in place of the ball 90 as described above, so that the direction and magnitude of the vehicle acceleration G can also be easily grasped.

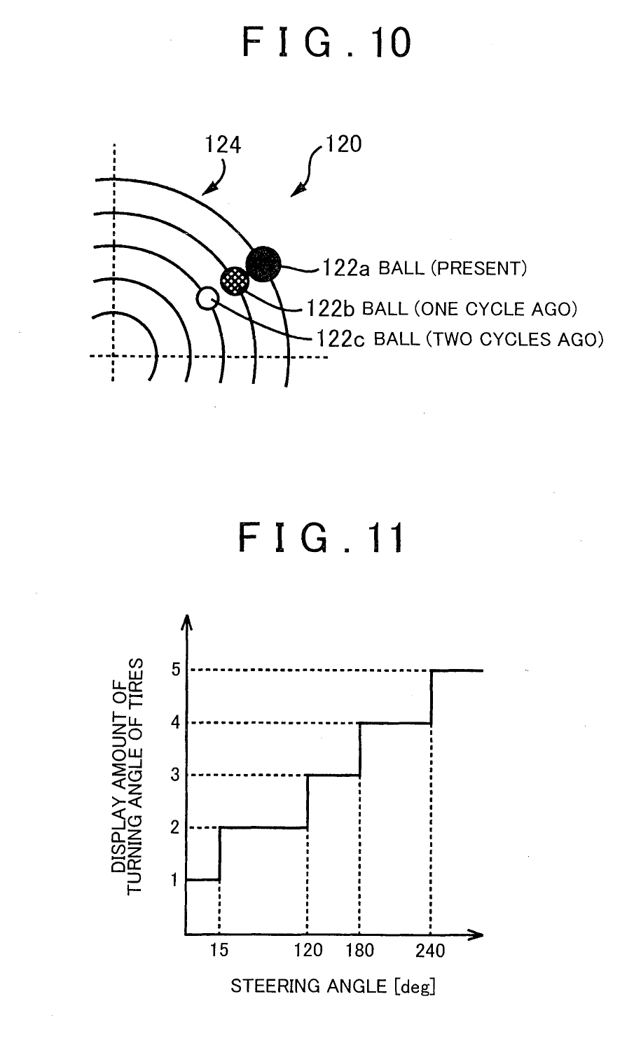

FIG. 10 is an enlarged view of a part (upper right portion) of concentric circles 124 indicating the vehicle acceleration G in a mimic vehicle diagram 120 according to a fourth embodiment of the invention. The remaining display area of the mimic vehicle diagram 120 is substantially the same as that of the above-described embodiments, and therefore, is not illustrated in FIG. 10. A ball 122a located on, a radially outermost circle shown in FIG. 10 indicates the current (or the latest) vehicle acceleration G. A ball 122b located inside the ball 122a indicates conditions of the vehicle acceleration G obtained a given period of time (or one cycle) prior to the present time, relative to the current vehicle acceleration G. A ball 122c located further inside the ball 122b indicates conditions of the vehicle acceleration G obtained the given period of time (or one cycle) prior to the present time. Namely, the ball 122b and the ball 122c represent previous vehicle accelerations G, and indicate a trajectory of the vehicle acceleration G (or changes in the vehicle acceleration G).

In this embodiment, the ball 122a indicating the current vehicle acceleration G is displayed most darkly or most brightly, and the balls (122b, 122c) indicating the previous vehicle accelerations G are displayed more lightly or more darkly in a stepwise fashion as the time at which the vehicle acceleration G was obtained is earlier. Accordingly, the ball 122c indicating the latest or oldest vehicle acceleration G is displayed most lightly. In this manner, the balls 122b, 122c corresponding to the previous vehicle accelerations G are displayed in the form of residual images against the ball 122a corresponding to the current vehicle acceleration G, so that the current vehicle acceleration G and the previous vehicle accelerations G can be easily distinguished from each other, and the driver can easily grasp changes in the vehicle acceleration G. In another example, the ball 122a indicating the current vehicle acceleration G is displayed in the largest size, and the balls (122b, 122c) indicating the previous vehicle accelerations G are displayed in smaller size in a stepwise fashion as the time at which the vehicle acceleration G was obtained is earlier. Accordingly, the ball 122c indicating the latest or oldest vehicle acceleration G is displayed in the smallest size. With the size of the ball 122 thus changed, the current vehicle acceleration G and the previous vehicle accelerations G can be distinguished from each other, and the driver can easily grasp changes in the vehicle acceleration G.

As described above, this embodiment provides the same or similar effects as the above-described embodiments. Furthermore, the previous vehicle accelerations G are displayed on the mimic vehicle diagram 120, so that changes in the vehicle acceleration G can be grasped as needed, and the driver can drive the vehicle, based on the changes in the vehicle acceleration G.

FIG. 11 indicates the relationship between the steering angle θ and display of the turning angle of the front wheels 84, according to a fifth embodiment of the invention, and corresponds to FIG. 4A of the first embodiment. In FIG. 4A as described above, the display amount of the turning angle of the front wheels 84 has a linear relationship with the steering angle θ. In this embodiment, on the other hand, the display amount of the turning angle of the front wheels 84 has a non-linear relationship with the steering angle θ, as shown in FIG. 11. More specifically, the display amount of the turning angle of the front wheels 84 changes to 2 when the steering angle θ reaches 15 degrees, and the display amount of the turning angle of the front wheels 84 changes to 3 when the steering angle θ reaches 120 degrees, for example. Also, the display amount of the turning angle changes to 4 when the steering angle θ reaches 180 degrees, and the display amount of the turning angle changes to 5 when the steering angle θ reaches 240 degrees. In this embodiment, the steering angle θ at which the display amount of the turning angle changes is set to the steering angle at which the driving force control of the vehicle switches from one mode to another. For example, if the steering angle θ reaches 15 degrees, the driving force control switches from the 2WD traveling mode to driving force distribution control (torque distribution control) under which the driving force is distributed to the front and rear wheels. Namely, the steering angle θ of 15 degrees is a threshold value based on which the control switches to the driving force distribution control (torque distribution control). Also, if the steering angle θ reaches 180 degrees, for example, driving force distribution control for preventing a tight corner braking phenomenon is started, and the distribution of the driving force between the front and rear wheels is changed according to the driving force distribution control. Namely, the steering angle θ of 180 degrees is a threshold value based on which the control for preventing the tight corner braking phenomenon is started. Thus, the display amount of the turning angle of the front wheels 84 is set so as to be changed at the steering angle θ (time) at which the control related to the distribution of the driving force between the front and rear wheels (or right and left wheels) switches, so that the display amount of the turning angle of the front wheels 84 is changed at the same time that the driving force distribution control is switched. Thus, the relationship between the steering angle θ and the distribution of the driving force will be further easily understood. Accordingly, the driver is able to easily grasp switching of the driving force distribution control based on change of the steering angle θ. The specific control modes or arrangements will not be described herein, since the turning angle of the front wheels 84 is merely displayed based on the relationship between the steering angle θ and the display amount of the turning angle of the front wheels 84 as shown in FIG. 11, instead of the above-described relationship as indicated in FIG. 4.

As described above, this embodiment provides the same or similar effects as the above-described embodiments. Also, the display amount of the turning angle of the front wheels 84 is set so as to be changed at the steering angle θ at which the driving force distribution control is switched from one mode to another. Accordingly, the driver is able to easily grasp the relationship of the driving force distribution control with change of the steering angle θ.

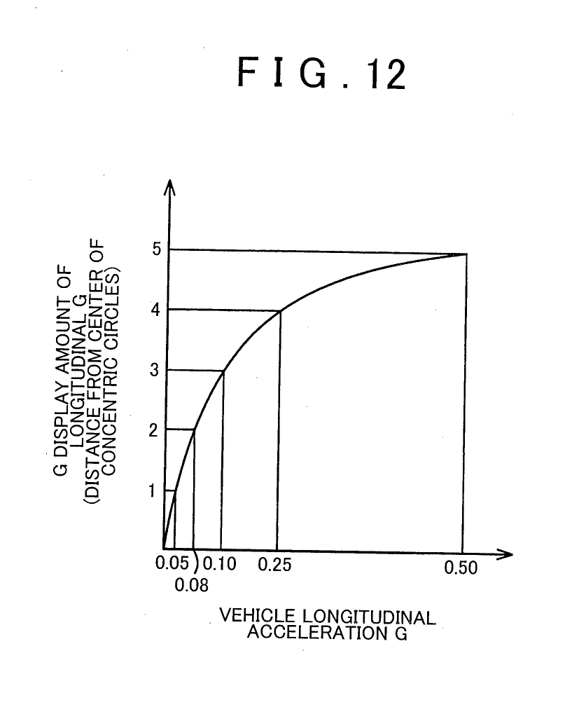

FIG. 12 shows the relationship between the vehicle acceleration G and the G display amount (the distance of the concentric circle from the center of the concentric circles) of the vehicle acceleration G according to a sixth embodiment of the invention, and corresponds to FIG. 5 as described above. In FIG. 5, the G display amount (the distance of the concentric circle from the center of the concentric circles, the display position of the ball 90) is linearly changed relative to the vehicle acceleration G. In this embodiment, as shown in FIG. 12, the G display amount is non-linearly changed relative to the vehicle acceleration G. More specifically, the G display amount of the vehicle acceleration G changes at a large rate when the vehicle acceleration G is in a small region. Namely, the gain in a small region of the vehicle acceleration G is set to be larger than that in a large region thereof, so that the G display amount of the vehicle acceleration G is more likely to be changed when the vehicle acceleration G is in the small region (the gain when the vehicle acceleration G is small is set such that the gain when the vehicle acceleration G is low is larger than the gain when the vehicle acceleration G is high, to make the display of the vehicle acceleration G be more likely to change as the vehicle acceleration G is lower). Accordingly, the display of the vehicle acceleration G is more likely to be changed in the small region of the vehicle acceleration and the driver can grasp even a small change in the vehicle acceleration G in this region. This type of display is set in the case where the vehicle 10 is in a regular operating region, for example. The regular operating region is set to an operating region (e.g., a small-acceleration-stroke, low-vehicle-seed region) in which the load applied to the vehicle 10 is small.

As described above, this embodiment provides the same or similar effects as the above-described embodiments. Also, the gain is set so that the display of the vehicle acceleration G is easily changed, in the regular operating region, whereby the driver can grasp even a small change in the vehicle acceleration G.

While some embodiments of the invention have been described in detail with reference to the drawings, the invention may be applied in other forms.

For example, each of the above-described embodiments is described as an independent form, but two or more of the embodiments may be combined as needed and implemented. For example, the invention may be implemented by using at least one of the forms of the third embodiment through the sixth embodiment, in the mimic vehicle diagram 64 of the first embodiment. The invention may also be implemented by using at least one of the forms of the third embodiment through the sixth embodiment, in the mimic vehicle diagram 100 of the second embodiment.

While the vehicle 10 is depicted in a perspective view in the mimic vehicle diagram 64, this invention is not necessarily limited to this arrangement. For example, the vehicle 10 may be depicted in a view as seen from above, namely, may be depicted in a plan view.

In the above-described embodiments, the driving force of each wheel, the vehicle acceleration G and the turning angle of the front wheels 84 are displayed at the same time on the mimic vehicle diagram. However, the turning angle of the front wheels 84 may not be changed.

In the flowchart of the first embodiment, the order of steps may be changed as needed. For example, the abnormality detection of step S4 may be carried out first, and the order of steps S1 to S3 may be freely changed without being particularly limited. Also, steps S1 to S3 may be executed at the same time. Also, step S4 and step S6 may be eliminated. Namely, display that informs the driver of an abnormality when it is detected may be omitted.

Also, in the first embodiment, the ball 90 is displayed on one of the concentric circles. However, the shape of the symbol indicating the vehicle, acceleration G is not limited to a sphere. Rather, the ball 90 may be changed as needed to a symbol having the shape of a triangle, a quadrangle, or a star, provided that the symbol enables the driver to grasp the vehicle acceleration G.

In the above-described embodiments, the vehicle acceleration G is displayed in the form of the ball 90 or the arrow 114, for example, on the mimic vehicle diagram. However, the form of display may be set so as to be changed in accordance with the preference of the driver.

In the fourth embodiment as shown in FIG. 10, two previous vehicle accelerations G are indicated in addition to the current vehicle acceleration G. However, the number of symbols representing previous vehicle accelerations G is not particularly limited. For example, only one previous vehicle acceleration G immediately before the current one, or three or more previous vehicle accelerations G, may be indicated.

In the fifth embodiment as shown in FIG. 11, the display amount of the turning angle of the front wheels 84 changes when the steering angle θ is equal to 15 degrees, and the display amount also changes when the steering angle θ is equal to 120 degrees, 180 degrees, and 240 degrees. However, these specific numeral values are mere examples, and may be changed according to a control mode, etc. of the vehicle.

In the above-described embodiments, the turning angle of the front wheels 84 is changed in a stepwise fashion on the mimic vehicle diagram. However, the turning angle of the front wheels 84 may be continuously changed. Also, the turning angle of the rear wheels 84 in addition to that of the front wheels 84 may be changed and displayed, if the vehicle is equipped with a four-wheel steering system capable of changing the turning angles of the front and rear wheels.

In the above-described embodiments, the 4WD-ECU 42 that controls driving conditions and the display system control ECU 46 are individually or separately provided in the electronic control unit 40. However, a single ECU may perform functions of the 4WD-ECU and the display system control ECU. The ECU may also be further divided into sub-units for performing given functions.

While the vehicle 10 is the FF-based four-wheel-drive vehicle in the above-described embodiments, the invention is not limitedly applied to the four-wheel-drive vehicle. For example, the invention may be applied to a two-wheel-drive vehicle of a front-wheel drive type or a rear-wheel drive type. Also, in the vehicle 10, the rear wheels 86 are provided with the right-left-wheel driving force distribution mechanism 30. However, the right-left-wheel driving force distribution mechanism may not be provided, but only an electronically controlled coupling that controls the distribution of the driving force between the front and rear wheels may be provided. Also, the front wheels 14, rather than the rear wheels 16, may be provided with a right-left-wheel driving force distribution mechanism, or the front wheels 14 and the rear wheels 16 may be provided with right-left-wheel driving force distribution mechanisms. A specific arrangement for distributing the driving force is not limited to that of the above-described embodiments, but may be selected from other arrangements.

While the vehicle 10 is displayed in perspective in the mimic vehicle diagram in the above-described embodiments, the vehicle 10 need not be displayed in perspective, but may be displayed in a plan view.

In the above-described embodiments, the center of the concentric circles is set in the vicinity of the center of the mimic vehicle diagram, or in the vicinity of the seated position of the driver. However, the center of the concentric circles may be set to another location provided that the driver can easily grasp conditions of the vehicle acceleration G.

While the G display amount is determined based on the vehicle longitudinal acceleration G, as shown in FIG. 5, in the above-described embodiments, the G display amount may also be determined in view of the vehicle lateral acceleration as well as the vehicle longitudinal acceleration.

It is to be understood that the above-described embodiments are mere examples, and that the invention can be implemented in other forms with various changes or improvements, based on the knowledge of those skilled in the art.

1. A display control system for a vehicle, the vehicle including a display installed inside the vehicle, the display control system comprising
an electronic control unit configured to control the display such that
(a) traveling conditions of the vehicle are displayed using a mimic vehicle diagram displayed on the display, and
(b) driving force of wheels, magnitude of a vehicle acceleration and a direction of the vehicle acceleration are displayed on one of the mimic vehicle diagram and a vicinity of the mimic vehicle diagram.

2. The display control system according to claim 1, wherein
the magnitude of the vehicle acceleration and the direction of the vehicle acceleration are indicated by converting the vehicle acceleration into a form that enables the vehicle acceleration to be visually grasped on the mimic vehicle diagram, and the vehicle acceleration is directly detected or calculated.

3. The display control system according to claim 1, wherein
the electronic control unit is configured to control the display such that
(i) the magnitude and the direction of the vehicle acceleration are indicated by a position of a symbol placed on a plurality of concentric circles arranged about the same center, and
(ii) a distance from the same center to the position of the symbol increases as the vehicle acceleration is larger.

4. The display control system according to claim 3, wherein
the center of the concentric circles is located in one of a vicinity of a center of the mimic vehicle diagram and a vicinity of a seated position of a driver.

5. The display control system according to claim 3, wherein
the electronic control unit is configured to control the display such that
(i) a residual image indicating a trajectory of the symbol is displayed, and
(ii) the symbol is displayed more lightly as a point in time at which the vehicle acceleration represented by the symbol is obtained is earlier.

6. The display control system according to claim 3, wherein
the electronic control unit is configured to control the display such that
(i) at least one of a size, a color density, or a color of the symbol is changed according to the position of the symbol, and
(ii) the size of the symbol is larger, the color of the symbol is darker, or the symbol is indicated in another color, as the distance from the center of the concentric circles to the position of the symbol increases, or
the size of the symbol is larger, the color of the symbol is darker, or the symbol is indicated in another color, when the distance from the center of the concentric circles to the symbol reaches a predetermined distance, as compared with the case where the distance from the center of the concentric circles to the symbol does not reach the predetermined distance.

7. The display control system according to claim 3, wherein
the electronic control unit is configured to control the display such that the concentric circles are displayed in perspective, in accordance with perspective display of the vehicle.

8. The display control system according to claim 1, wherein
the electronic control unit is configured to control the display such that the magnitude and the direction of the vehicle acceleration are indicated by an arrow having an origin located at one point on the mimic vehicle diagram.

9. The display control system according to claim 3, wherein
the electronic control unit is configured to control the display such that the symbol is fixed to the center of the concentric circles, or the symbol is not displayed, when an abnormality occurs to detection or calculation of the vehicle acceleration.

10. The display control system according to claim 1, wherein
the electronic control unit is configured to control the display such that an amount of steering of a driver is indicated by a turning angle of a tire in the mimic vehicle diagram.

11. The display control system according to claim 10, wherein
the electronic control unit is configured to change the turning angle of the tire relative to the amount of steering of the driver, at a time when driving force distribution control is switched from one mode to another.

12. The display control system according to claim 10, wherein
the electronic control unit is configured to set a gain such that the gain when the vehicle acceleration is low is larger than the gain when the vehicle acceleration is high, to make the display of the vehicle acceleration be more likely to change as the vehicle acceleration is lower.

13. The display control system according to claim 10, wherein
the electronic control unit is configured to set the turning angle to zero when an abnormality occurs to detection of the amount of steering of the driver.

14. The display control system according to claim 9, wherein
the electronic control unit is configured to perform one of the following operations when the abnormality occurs, so as to inform a driver of the abnormality;
(a) turning off a light illuminating a part of or the whole of a display area of the mimic vehicle diagram,
(b) blinking a part of or the whole of the display area of the mimic vehicle diagram,
(c) displaying a character on the mimic vehicle diagram,
(d) displaying a symbol on the mimic vehicle diagram, or
(e) generating sound.

15. The display control system according to claim 1, wherein
the vehicle includes a drive unit that performs at least one of distribution of driving force between front and rear wheels, or distribution of driving force between right and left wheels.
